(19) United States
(12) Patent Application Publication
(10) Pub. No.: US 2014/0210287 A1
(43) Pub. Date: Jul. 31, 2014

(54) Annular-Shaped Stator Structure and Method of Manufacture

(71) Applicants: Chun-Yuan WANG, Taipei (TW); Chih-Chin CHANG, Taipei (TW)

(72) Inventors: Chun-Yuan WANG, Taipei (TW); Chih-Chin CHANG, Taipei (TW)

(73) Assignee: Victory Industrial Corporation, Taipei (TW)

(21) Appl. No.: 13/753,554

(22) Filed: Jan. 30, 2013

(51) Int. Cl. H02K 15/02; H02K 3/34; H02K 3/30; H02K 1/04; H02K 3/02; H02K 3/28; H02K 1/16

(52) U.S. Cl. CPC H02K 15/02; H02K 3/28; H02K 3/345; H02K 1/16; H02K 1/04; H02K 3/02; H02K 3/30
USPC 310/71; 310/203; 29/596

(57) ABSTRACT

A method of manufacturing an annular-shaped stator structure includes forming an elongate stator body, the elongate stator body extending along a longitudinal axis, the elongate stator body including first and second ends and a plurality of slots. Electrically-conductive wires are inserted into the slots of the elongate stator body, whereby each of the electronically conductive wires includes a first end and a second end. The elongate stator body is then formed into an annular shape. The first end of the annular-shaped stator body is coupled to the second end of the annular-shaped stator body, and the first end of each electrically-conductive wire is coupled to that wire's respect second end.

### BACKGROUND

The present invention relates to a stator structure and method of manufacture, and more particularly to an annular-shaped stator structure which is initially formed as an elongate-shaped stator structure, and subsequently shaped to form an annular-shaped stator structure.

Stator structures are used in electrical equipment and machinery which are used to generate and supply electrical power. As one common example, stator structures are used in alternators of automobiles to supply electrical power to operate the automobile's accessories. Stators are also used in other machines, e.g., wind or steam turbines, and many other machines which employ motors for various purposes.

Conventionally, a stator is manufactured in an integral, single piece form with an annular shape that is to be disposed around a central rotor so that inductive interaction therebetween generates electricity. Slots which are machined into the annular stator are then wound with conductive wires to enable power generation by induction. Because of the annular shape of the stator, the spacing within each slot narrows as the slot walls extend toward the center of the stator, making it difficult to arrange the copper wires neatly and compactly within each slot. As a result, the number of turns of the copper wires wound around the stator tends to be insufficient, and the total area of the copper wires cannot be increased, which leads to an increase in the operating temperature of the alternator, and a high resistive loss of the stator ring. Consequently, the conventional stator structure limits the overall performance of the alternator or other component which relies upon stator structure.

### SUMMARY

An annular-shaped stator structure and method of manufacture is described herein to overcome the aforementioned drawbacks of the prior art. In one embodiment, the method of manufacturing an annular-shaped stator structure includes forming an elongate stator body, the elongate stator body extending along a longitudinal axis and having first and second ends, and a plurality of slots. Electrically-conductive wires are inserted into the slots of the elongate stator body, whereby each of the electronically conductive wires includes a first end and a second end. The elongate stator body is then formed into an annular shape. The first end of the annular-shaped stator body is coupled to the second end of the annular-shaped stator body, and the first end of each electrically-conductive wire is coupled to that wire's respect second end.

This and other aspects and features of the invention are further described in the following detailed description and drawings.

### BRIEF DESCRIPTION OF THE DRAWINGS

FIG. 1 illustrates a method for manufacturing an annular-shaped stator structure in accordance with one embodiment of the present invention;

FIG. 2 illustrates an exploded perspective view of an elongate stator structure in accordance with one embodiment of the present invention;

FIG. 3 illustrates an operation of inserting electrically-conductive wires into slots of the elongate stator body before annular formation of the stator body in accordance with one embodiment of the present invention;

FIG. 4 illustrates an operation of forming the elongate stator body with inserted electrically-conductive into an annular shape in accordance with one embodiment of the present invention;

FIG. 5 illustrates a top view of stator structure once its form has been shaped into an annular ring in accordance with one embodiment of the present invention.

FIG. 6 illustrates an exploded perspective view of the annular-shaped stator shown in FIG. 5;

FIG. 7 illustrates the operation of soldering the two ends of the annular-shaped stator body together in accordance with one embodiment of the present invention; and

FIG. 8 illustrates an assembled perspective view of an annular-shaped stator structure manufactured in accordance with FIG. 1.

For clarity, previously-described features retain their reference indices in subsequent drawings.

### EXEMPLARY EMBODIMENTS OF THE INVENTION

The contents, technical features, and advantages of the present invention are hereinafter detailed by way of embodiments thereof with reference to the accompanying drawings. The drawings are intended only to be illustrative and supplementary to the present specification and are not necessarily drawn to scale or precisely according to the physical arrangement of the components. Therefore, the proportions and arrangements shown in the accompanying drawings impose no limitations on the scope of the present invention in practice.

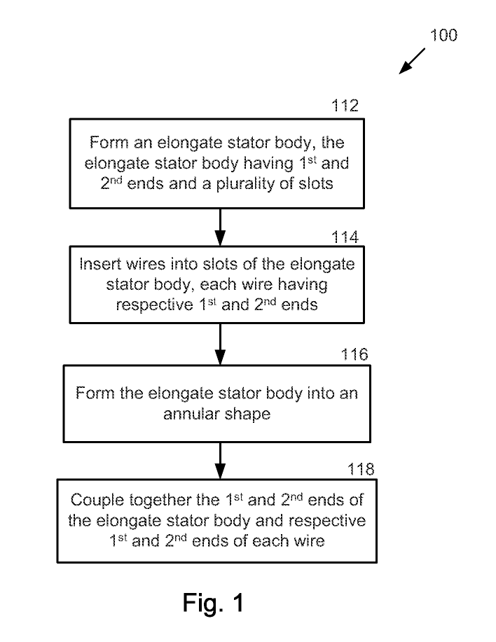

FIG. 1 illustrates a method for manufacturing an annular-shaped stator structure in accordance with one embodiment of the present invention. The method 100 includes forming an elongate stator body having first and second ends and a plurality of slots (operation 112). Electrically-conductive wires, each wire having respective first and second ends, are inserted into slots of the elongate stator body (operation 114). The elongate stator body is formed into an annular shape (operation 116). The first and second ends of the elongate stator body and coupled together, and the respective first and second ends of each of the electrically-conductive wires are coupled together (operation 118) to complete the annular-shaped stator structure.

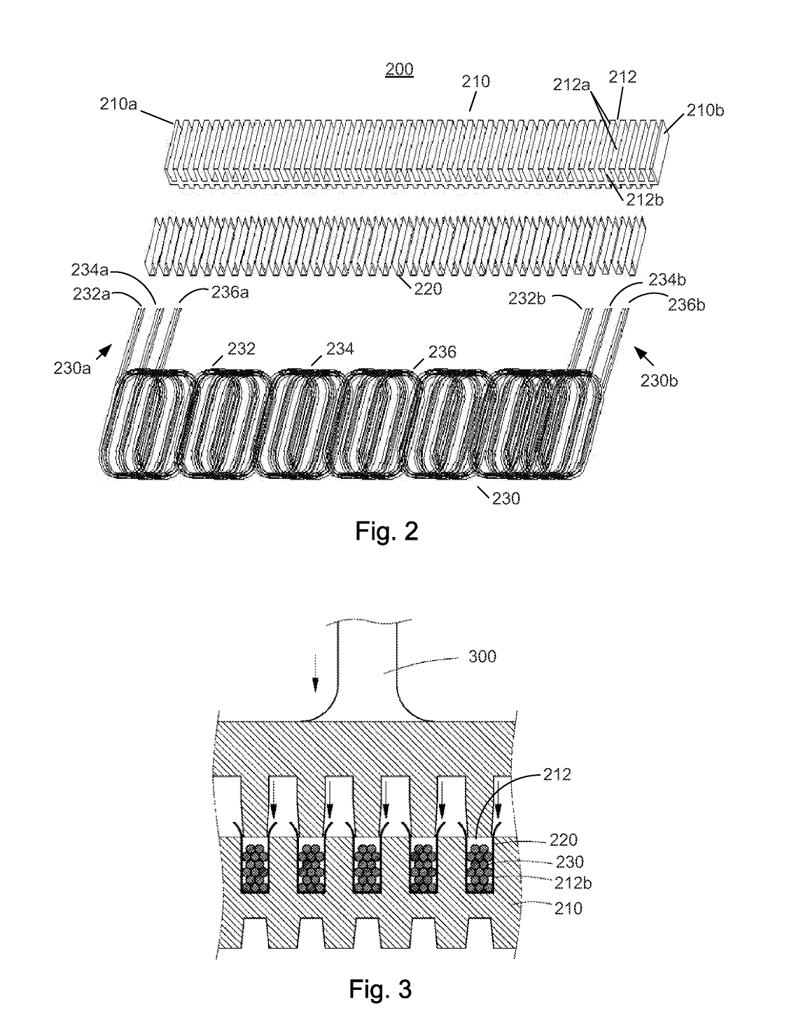

FIG. 2 illustrates an exploded perspective view of an elongate stator structure in accordance with one embodiment of the present invention. The elongate stator structure 200 includes an elongate stator body 210 extending along a longitudinal axis and having first and second ends 210a and 210b, and a plurality of slots 212, each slot 212 formed by spaced-apart walls 212a (T-shaped claws in one embodiment) and a surface 212b forming the interior of the slot in which wires are to be located. Exemplary, the slots 212 are formed with uniform length, width and depth dimensions, which permits a greater density of wires to be packed or inserted each slot 212, thereby providing some of the advantages described above.

In exemplary embodiments, the elongate stator body 210 is formed from a material which retains its electrical and magnetic field properties when its shaped is changed. Exemplary materials include SPCC, silicon steel, and similar materials.

Further exemplary, the elongate stator body 210 further includes one or more electrically-insulating plates 220 disposed along the surface 212b of the slots 212. In one embodiment, each slot 212 is provided a separate electrically-insulating plate 220. In an alternative embodiment, one continuous sheet/plate of insulating material is used, whereby a portion of the electrically-insulating material is disposed along the surface 212b of two or more slots 212. Exemplary, the electrically-insulating plate(s)/sheet(s) 220 is constructed from an electrically non-conductive material, such as press paper, plastic films, polyester films, aramide paper, epoxy, and similar materials.

The elongate stator structure 200 further includes a plurality of electrically-conductive wires 230 which are inserted into the slots 212 of the elongate stator body 210. Each of the wires 230 have respective first and second ends 230a and 230b. In a specific exemplary embodiment, the wires 230 are separated into wire groups 232, 234, 236, each wire in each group having a first end 232a, 234a, 236a and a second end 232b, 234b and 236b. For example, a first group of wires 232 is arranged for insertion into the 1^{st}, 4^{th}, 7^{th}, and 10^{th} slots 212 of the elongate stator body 210; a second group of wires 234 are arranged for insertion into the 2^{nd}, 5^{th}, 8^{th}, and 11^{th} slots 212 of the elongate stator body 210; and a third group of wires 236 are arranged for insertion into the 3^{rd}, 6^{th}, 9^{th}, and 12^{th} slots 212 of the elongate stator body 210. Although three wire groups 232, 234 and 236 are shown, any number of wire groups may be employed in alternative embodiments of the present invention. Exemplary, the electrically-conductive wire is copper wire, although other types of conductive material may be used in alternative embodiments.

FIG. 3 illustrates an operation of inserting electrically-conductive wires 230 into slots 212 of the elongate stator body 210 before annular formation of the stator body in accordance with one embodiment of the present invention. As shown, each of the first, second and third wire groups 232, 234 and 236 are inserted and compacted into their respective slots 212, whereby the electrically-insulating plates/sheets being disposed between the wires 230 and the slot surface 212. Exemplary, the tool 300 is a hydraulic mechanism, but alternative machine types may be used in accordance with alternative embodiments of the present invention.

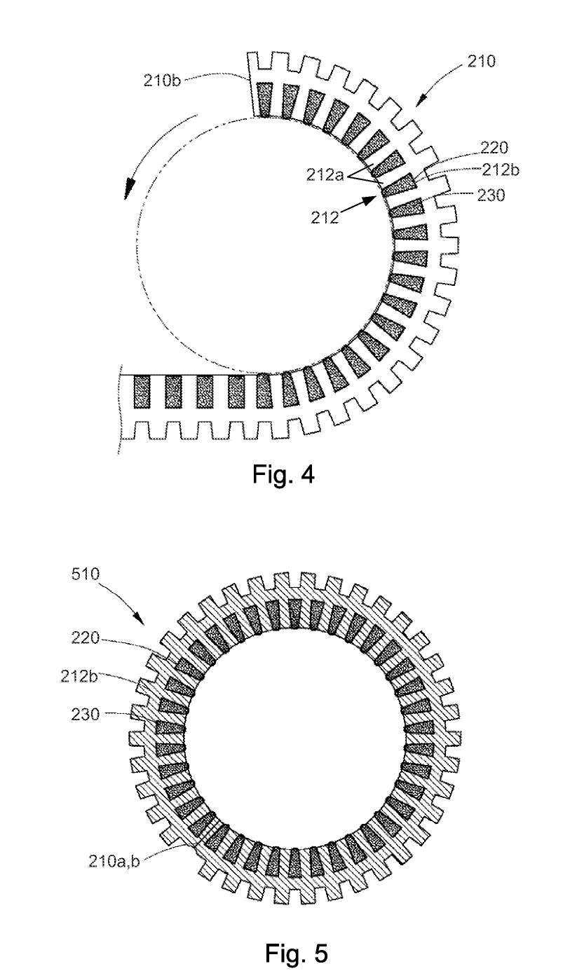

FIG. 4 illustrates an operation of forming the elongate stator body 210 with inserted electrically-conductive wires 230 into an annular shape in accordance with one embodiment of the present invention. In particular, once the elongate stator body 210 is loaded with the insulating plates 220 and wires 230, the elongate stator body 210 is rolled into an annular shape. This is shown in FIG. 4 as the second end 210b of the elongate stator body 210 being rolled to an annular shape proximate to the first end 210a. Exemplary, the elongate stator body 210 is cold rolled.

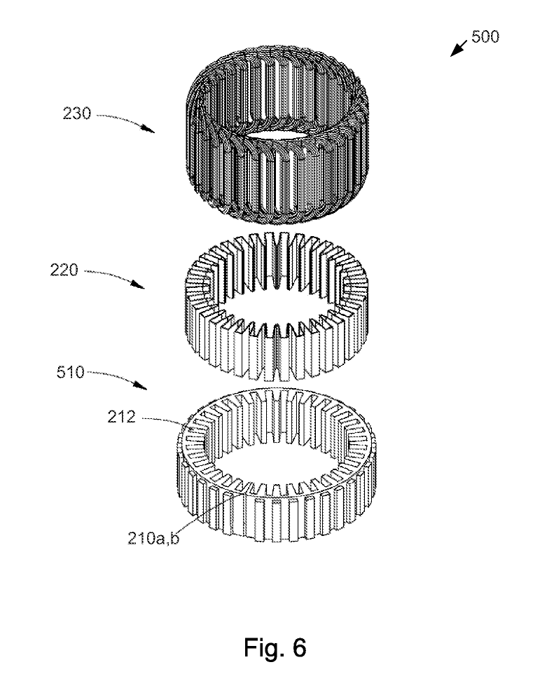

FIGS. 5 and 6 illustrate top and exploded views, respectively, of the stator structure once its has been shaped into an annular ring in accordance with one embodiment of the present invention. The annular-shaped stator structure now includes an annular-shaped stator body 510, along with the previously-described insulating plates 220 disposed between the wires 230 and the slot surface 212b. The annular-shaped stator body 510 further includes proximately-located first and second ends 210a and 210b. Although not shown, the first and second ends of each of the wires 230 are also proximately located.

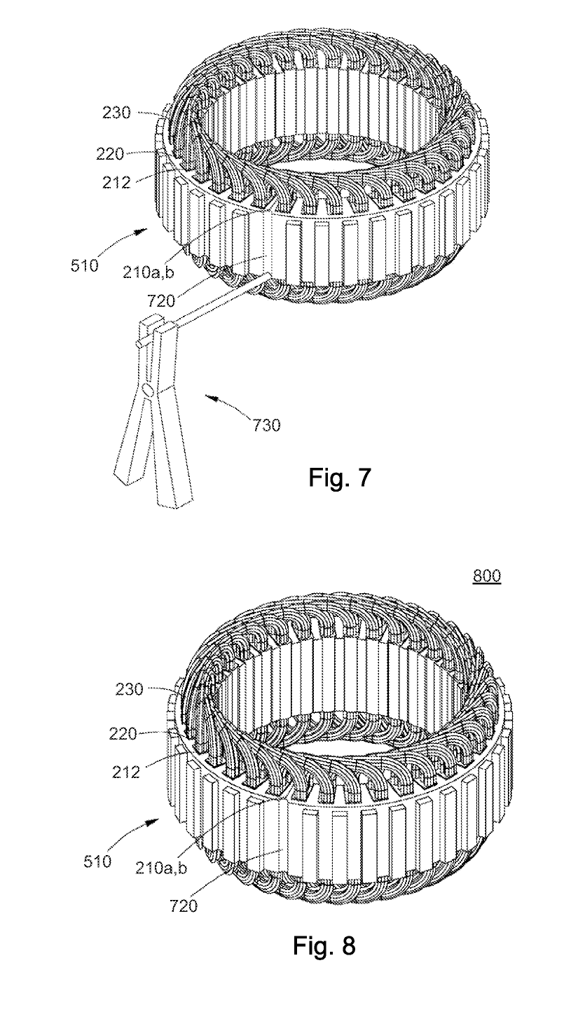

FIG. 7 illustrates the operation of soldering the ends of the annular-shaped stator body together in accordance with one embodiment of the present invention. The first and second ends 210a and 210b are coupled together, exemplary, by means of a solder joint 720 formed between the first and second ends 210a, 210b of the annular-shaped stator body 510, using a soldering apparatus 730. Although not shown, the first and second ends of each of the wires are also coupled together, exemplary by means of a solder joint between the first and second ends of each wire.

FIG. 8 illustrates a perspective view of an annular-shaped stator structure 800 manufactured in accordance with the method of FIG. 1. In this stator structure 800, the wires 230 are arranged compactly and with a higher density compared with convention stator structures. Such a configuration is effective in lowering not only the temperature of an alternator using the stator structure, but also the resistive loss of the stator structure.

Embodiments of the present invention include:

A method of manufacturing a stator structure, in which an elongate stator body 210 is formed along a longitudinal axis and in which the elongate stator body includes first and second ends 210a and 210b and a plurality of slots 212. A plurality of electrically-conductive wires 230, each wire having a first end 230a and a second end 230b, is inserted within the slots, and the elongate stator body is formed into an annular shape. The first and second ends 210a and 210b of the annular shaped stator body 510 are coupled together, and the first and second ends of each of wire are coupled together.

Further exemplary of the method of manufacturing, each slot 212 includes a surface 212b for receiving the electrically-conductive wires 230, and an electrically-insulating plate 220 is inserted into one or more of the slots 212 of the elongate stator body, wherein the electrically-insulating plate 220 is disposed between the slot surface 212b and the plurality of electrically-conductive wires 230 disposed therein.

Further exemplary, the elongate stator body 210 is made from SPCC, or Silicon steel, the electrically-insulating plates 220 are made from press paper, plastic films, polyester films, aramide paper, or epoxy, and the electrically-conductive wires 230 are made from copper.

Further exemplary, the first and second ends of the annular-shaped stator body are coupled together by means of a solder joint 720. Further exemplary, the first and second ends of each wire are coupled together by means of a solder joint.

The present invention further includes an annular-shaped stator structure produced from the foregoing method of manufacturing.

The present invention further includes a stator structure 800 having an annular-shaped stator body 510 having first and second ends 210a, 210b and a plurality of slots 212 disposed thereon. The stator structure 800 further includes a plurality of electrically-conductive wires 230 disposed within the slots of the annular-shaped stator body, each of the electronically-conductive wires comprising a first end 230a and a second end 230b. The first end of the annular-shaped stator body is coupled to the second end of the annular-shaped stator body, and, for each of the plurality of electrically conducting wires, the first end of electrically-conductive wire is coupled to the second end of said electrically-conductive wire.

Further exemplary of the stator structure 800, each slot 212 includes a surface 212b for receiving the electrically-conductive wires 230, the stator structure 800 further including an electrically-insulating plate 220 disposed between the slot surface 212b and the plurality of electrically-conductive wires 230 disposed therein.

Further exemplary, the elongate stator body 210 is made from SPCC, or silicon steel, the electrically-insulating plates 220 are made from press paper, plastic films, polyester films, aramide paper, or epoxy, and the electrically-conductive wires 230 are made from copper.

Further exemplary, the first and second ends of the annular-shaped stator body are coupled together by means of a solder joint 720. Further exemplary, the first and second ends of each wire are coupled together by means of a solder joint.

The annular-shaped stator structure of the present invention has application in alternator systems, for example, in power generation systems and vehicles. A particular application of the invention is as a stator structure in an automobile alternator.

The embodiments described above serve only to demonstrate the technical concept and features of the present invention, thereby enabling a person skilled in the art to understand the contents of the present invention and implement the invention accordingly. The foregoing embodiments, however, are not restrictive of the scope of the present invention. All equivalent changes or modifications made in accordance with the concept disclosed herein should fall within the scope of the appended claims.

What is claimed is:

1. A method of manufacturing an annular-shaped stator structure, the method comprising:
forming an elongate stator body along an longitudinal axis, the elongate stator body comprising first and second ends and a plurality of slots;
inserting a plurality of electrically-conductive wires into the slots of the elongate stator body, each of the electronically conductive wires comprising a first end and a second end;
forming the elongate stator body into an annular shape; and
coupling the first end of the annular-shaped stator body to the second end of the annular-shaped stator body, and for each of the plurality of electrically conducting wires, coupling the first end of an electrically-conductive wire to the second end of said electrically-conductive wire.

2. The method of claim 1, wherein the elongate stator body comprises a material selected from the group consisting of SPCC and silicon steel.

3. The method of claim 1, wherein the plurality of electrically-conductive wires comprises copper.

4. The method of claim 1, wherein forming the elongate stator body comprises forming the elongate stator body having the electrically-conductive wires disposed thereon into an annular shape.

5. The method of claim 1, wherein coupling comprises soldering the first end of the annular-shaped stator body to the second end of the annular-shaped stator body, and for each of the plurality of electrically-conducting wires, soldering the first end of an electrically-conductive wire to the second end of said electrically-conductive wire.

6. The method of claim 1, wherein each slot comprises a surface for receiving the electrically-conductive wires, the method further comprising inserting an electrical insulator into each slot of the elongate stator body, wherein the electrical insulator is disposed between the surface of the slot and the plurality of electrically-conductive wires disposed therein.

7. The method of claim 8, wherein the electrical insulator comprises a material selected from the group consisting of press paper, plastic films, polyester films, aramide paper, and epoxy.

8. An annular-shaped stator structure, comprising:
an annular-shaped stator body comprising first and second ends and a plurality of slots;
a plurality of electrically-conductive wires disposed within the slots of the annular stator body, each of the electronically-conductive wires comprising a first end and a second end;
wherein the first end of the annular-shaped stator body is coupled to the second end of the annular-shaped stator body, and
wherein, for each of the plurality of electrically conducting wires, the first end of an electrically-conductive wire is coupled to the second end of said electrically-conductive wire.

9. The annular-shaped stator structure of claim 8, wherein each slot comprises a surface for receiving the electrically-conductive wires, the stator structure further comprising an electrical insulator disposed between the surface of the slot and the plurality of electrically-conductive wires disposed therein.

10. The annular-shaped stator structure of claim 8, wherein the coupling formed between the first and second ends of the annular-shaped stator body comprises a solder connection.

11. The annular-shaped stator structure of claim 8, wherein the coupling formed between the first and second ends of each electrically-conductive wire comprises a solder connection.

12. The annular-shaped stator structure of claim 8, wherein the annular-shaped stator body comprises a material selected from the group consisting of SPCC and silicon steel, and wherein the annular-shaped stator body is formed into an annular shape from an elongate shape.

13. The annular-shaped stator structure of claim 8, wherein the electrically-conductive wires comprise copper.

14. The annular-shaped stator structure of claim 8, wherein the electrical insulator comprises a material selected from the group consisting of press paper, plastic films, polyester films, aramide paper, and epoxy.

15. An alternator, comprising an annular-shaped stator structure, the annular-shaped stator structure comprising:
an annular-shaped stator body comprising first and second ends and a plurality of slots;
a plurality of electrically-conductive wires disposed within the slots of the annular stator body, each of the electronically-conductive wires comprising a first end and a second end;
wherein the first end of the annular-shaped stator body is magnetically coupled to the second end of the annular-shaped stator body, and
wherein, for each of the plurality of electrically conducting wires, the first end of an electrically-conductive wire is electrically-coupled to the second end of said electrically-conductive wire.

16. The alternator of claim 15, wherein the alternator is a vehicle alternator.

17. The alternator of claim 16, wherein the alternator is an automobile alternator.
